(19) United States
(12) Patent Application Publication
(10) Pub. No.: US 2010/0096337 A1
(43) Pub. Date: Apr. 22, 2010

(54) ULTRASONICALLY INDUCED CAVITATION OF FLUOROCHEMICALS

(76) Inventors: Brian T. Mader, Marine on the St. Croix, MN (US); Chad D. Vecitis, New Haven, CT (US); Michael R. Hoffmann, South Pasadena, CA (US)

Correspondence Address: 3M INNOVATIVE PROPERTIES COMPANY, PO BOX 33427, ST. PAUL, MN, 55133-3427, US

(21) Appl. No.: 12/529,404

(22) PCT Filed: Mar. 4, 2008
(86) PCT No.: PCT/US08/55754

§ 371 Date: Sep. 1, 2009

Related U.S. Application Data
(60) Provisional application No. 60/893,257, filed on Mar. 6, 2007.

(51) Int. Cl. C02F 1/36; C02F 101/14; C02F 103/06

(52) U.S. Cl. 210/738; 210/170.07

(57) ABSTRACT

A system for the treatment of groundwater is described, the system including: a first component for placement into a groundwater table, the first component having a first end and a second end and an interior space defined by an inner wall and extending between the first end and the second end; at least one ultrasonic transducer positioned with the interior space of the first component to provide ultrasonically induced cavitation to a volume of water within the interior space; a pump associated with the first end of the first component to draw water from the groundwater table into the interior space of the first component; an outlet associated with the second end of the first component, the outlet positioned to direct a volume of water away from the first component after the water has passed therethrough; a power supply; and a radio frequency generator capable of providing a radio frequency within the range from about 15 kHz to about 1100 kHz. A process for the treatment of fluorochemicals in an aqueous environment is also described, the process utilizing the foregoing system.

The present invention relates to systems and processes for the treatment of groundwater.

### BACKGROUND

Fluorochemicals have been used in a variety of applications including the water-proofing of materials, as protective coatings for metals, as fire-fighting foams for electrical and grease fires, for semi-conductor etching, and as lubricants. The main reasons for such widespread use of fluorochemicals is their favorable physical properties which include chemical inertness, low coefficients of friction, and low polarizabilities (i.e., fluorophilicity). Specific types of fluorochemicals include perfluorinated surfactants, perfluorooctane sulfonate (PFOS) and perfluorooctanoic acid (PFOA).

Although fluorochemicals are valuable as commercial products, they can be difficult to treat using conventional environmental remediation strategies or waste treatment technologies. Moreover, certain conventional treatment technologies may be ineffective for the treatment of fluorochemicals such as PFOS and PFOA when these compounds are present in the aqueous phase. Advanced oxidation processes that employ hydroxyl radicals derived from ozone, peroxone, or Fenton's reagent have been shown to react with PFOA, but these reactions tend to progress very slowly. PFOS and PFOA can be reduced by reaction with elemental iron under near super-critical conditions, but problems have been noted in the scale-up of a high-pressure, high temperature treatment system for implementing this reduction chemistry.

Improvements in the treatment of fluorochemicals are desired.

### SUMMARY

In one aspect, the present invention provides a system for the treatment of groundwater, comprising:
A first component for placement into a groundwater table, the first component having a first end and a second end and an interior space defined by an inner wall and extending between the first end and the second end;
At least one ultrasonic transducer positioned with the interior space of the first component to provide ultrasonically induced cavitation to a volume of water within the interior space;
A pump associated with the first end of the first component to draw water from the groundwater table into the interior space of the first component;
An outlet associated with the second end of the first component, the outlet positioned to direct a volume of water away from the first component after the water has passed therethrough;
A power supply; and
A radio frequency generator capable of providing a radio frequency within the range from about 15 kHz to about 1100 kHz.

In another aspect, the invention provides a process for the treatment of fluorochemicals in an aqueous environment, comprising:
Providing a system as described above wherein the first component and the pump are sunken below ground level into a groundwater table, the first end of the first component attached to the pump;
Drawing a volume of water into the interior space of the first component through the pump and the first end of the first component, the volume of water comprising fluorochemicals;
Ultrasonically inducing cavitation within the interior space at a frequency within the range from about 15 kHz to about 1100 kHz to thereby break down the fluorochemicals into constituent components; and
Removing the volume of water from the interior space through the second end thereof.

Terms used herein will be understood to have the same meaning as that understood by those skilled in the art. For clarity, certain terms are defined herein.

“Cavitation” refers to the formation, growth, and implosive collapse of bubbles in a liquid.

“Fluorochemical” means a halocarbon compound in which fluorine replaces some or all hydrogen molecules.

“Sonochemistry” refers to the chemical applications of ultrasound.

“Ultrasonic” refers to sound waves that have frequencies above the upper limit of the normal range of human hearing (e.g., above about 20 kilohertz).

“Ultrasonically induced cavitation” refers to cavitation that is directly of indirectly initiated by a source of ultrasonic energy such as ultrasonic transducers.

A consideration of the remainder of the disclosure will facilitate a better understanding of the various embodiments of the invention.

### BRIEF DESCRIPTION OF THE DRAWINGS

In describing the embodiments of the invention herein, reference is made to the various drawings, wherein:

FIGS. 1A-1C are plots showing a mass balance before and after cavitation for fluorine and sulfur for 10 μM aqueous solutions of PFOS (FIGS. 1A, 1B) and PFOA (FIG. 1C), as described in Example 1;

FIG. 2 schematically illustrates a degradation mechanism for PFOS;

FIGS. 3A-3B are plots showing the effect of initial PFOA or PFOS concentration on the rate of fluorochemical degradation, as described in Example 2;

FIG. 4 is a plot showing the effect of ultrasonic power density on the first-order rate constant of PFOA or PFOS degradation in aqueous solutions, as described in Example 3;

FIG. 5 is a plot of the degradation rate as a function of ultrasonic frequency for PFOA and PFOS, as described in Example 4;

FIG. 6 is a plot showing the degradation of PFOS over time for aqueous systems of differing origin, as described in Example 5;

FIG. 7 is a plot showing the degradation of C₄ and C₈ fluorochemicals, as described in Example 6;

FIG. 8 is a schematic representation of a system for the treatment of groundwater, according to an embodiment of the invention;

FIG. 9 is partial view, in cross section, of part of the system of FIG. 8 for the treatment of groundwater according to an embodiment of the invention;

FIG. 10 is a top view, in cross section, of the part depicted in FIG. 9, taken along the 10-10 line thereof;

FIG. 11 is a top view, in cross section, of a part of a system for the treatment of groundwater according to another embodiment of the invention; and

FIG. 12 is a top view, in cross section, of a part of a system for the treatment of groundwater according to still another embodiment of the invention.

### DETAILED DESCRIPTION

The present invention provides a means for achieving the conversion of fluorochemicals to constituent species such as carbon dioxide, fluoride ion and simple sulfates. In the various described embodiments of the invention, the cavitation of aqueous systems is described in which ultrasonically induced cavitation is used to facilitate the degradation of fluorochemicals in an aqueous environment. In the described embodiments, the treatment of fluorochemicals by cavitation may be accomplished under ambient conditions and without the use of chemical additives.

In the cavitation of aqueous systems in general, bubbles are continuously generated and are continuously collapsing. Not wishing to be bound to any theory, it is believed that, during the process of generation and collapse, a pyrolytic reaction occurs at the surface of collapsing cavitation bubbles to break down the structure of the fluorochemicals in an aqueous environment. Ultrasonically induced cavitation facilitates the formation and quasi-adiabatic collapse of vapor bubbles formed from existing gas nuclei. Subsequent transient cavitation results from the growth of such bubbles and their ultimate collapse. The vapors enclosed within the cavitation bubbles are known to attain temperatures from about 4000 to about 6000° K. upon dynamic bubble collapse. Nominal temperatures at the interface between collapsing bubble and the water are known to be in the range from about 500 to about 1000° K. The generation of such high temperatures provides in situ pyrolytic reactions in both the vapor phase and in the interfacial regions. The pyrolytic reactions also result in the breakdown of water into hydroxyl radical, hydroperoxyl radical, and atomic hydrogen. These radicals react readily with the compounds in the gas-phase and with the fluorochemicals adsorbed to the bubble interface.

Ultrasonically induced cavitation is effective for the degradation of the fluorochemical components that partition into the air-water interface, (e.g., compounds such as PFOS and PFOA) as well as compounds having high Henry's Law constants that may tend to partition into the vapor phase of the bubble. Such vapor phase constituents may include volatile fluorochemical fragments and the like.

In embodiments of the present invention, fluorochemicals are treated by using ultrasonically induced cavitation to thereby break down any of a variety of fluorochemicals in aqueous systems. These embodiments are effective for breaking down fluorochemicals having carbon chain lengths from C₁ and higher. In some embodiments, the fluorochemicals for which the invention is useful can include without limitation, Cᵢ compounds, C₂ compounds, C₄ compounds such as perfluorobutane sulfonate and the perfluorobutanoate anion (i.e., the conjugate base of perfluorobutanoic acid), C₆ compounds including the conjugate base of C₆ acids and C₆ sulfonates and C₈ fluorochemicals which include PFOS and PFOA (e.g., the conjugate base thereof), for example. Combinations of two or more of the foregoing are also contemplated within the scope of the invention as well as combinations of fluorochemicals with other organic and/or inorganic species. Moreover, the present invention is not limited in any manner by the source of the fluorochemicals being treated. For example, the fluorochemicals may be treated according to an embodiment of the invention regardless of whether the fluorochemicals materials originate from chemical storage facilities, comprise fire fighting foams (e.g., comprising PFOS and perfluorohexane sulfonate), chemical waste, or the like.

In embodiments of the invention, ultrasonic transducers provide ultrasonically induced cavitation to an aqueous system comprising fluorochemicals. Suitable ultrasonic transducers are available commercially such as those available from L-3 Nautik GMBH in Germany; Ultrasonic Energy Systems in Panama City, Fla.; Branson Ultrasonics Corporation of Danbury, Conn.; and Telsonics Ultrasonics in Bronschhofen, Germany.

In aqueous systems in which the concentrations of fluorochemicals is within the range from about 0.025 ng/mL to about 10⁶ ng/mL (1000 mg/L) ultrasonically induced cavitation may be accomplished using acoustic frequencies within the range from about 15 kHz to about 1100 kHz. In some embodiments, cavitation is accomplished using acoustic frequencies greater than 200 kHz. In some embodiments, cavitation is accomplished using acoustic frequencies ranging from greater than 200 kHz to about 1100 kHz. In other embodiments, cavitation is accomplished using acoustic frequencies within the range from greater than 200 kHz to about 600 kHz.

In an embodiment, cavitation is accomplished using an acoustic frequency of about 20 kHz. In another embodiment, cavitation is accomplished using an acoustic frequency of about 205 kHz. In another embodiment, cavitation is accomplished using an acoustic frequency of about 358 kHz. In another embodiment, cavitation is accomplished using an acoustic frequency of about 500 kHz. In still another embodiment, cavitation is accomplished using an acoustic frequency of about 618 kHz. In still another embodiment, cavitation is accomplished using an acoustic frequency of about 1078 kHz.

In any of the foregoing embodiments, suitable power densities may typically range from about 83 to about 333 W L⁻¹. Variations to the power densities at a given frequency can effect the overall degradation rate of a fluorochemical, and the present invention is not limited in any way by the power density ranges described herein. Power densities may be varied as needed or desired and can be less than about 83 W/L or greater than about 333 W/L. The degradation of the fluorochemicals may be confirmed using one or more suitable analytical techniques known to those skilled in the art for the analysis of the gaseous components and for the detection of compounds in water. Suitable techniques include liquid chromatography, gas chromatography, mass spectroscopy, infrared spectroscopy, and ultraviolet/visible (UV/vis) spectroscopy, for example.

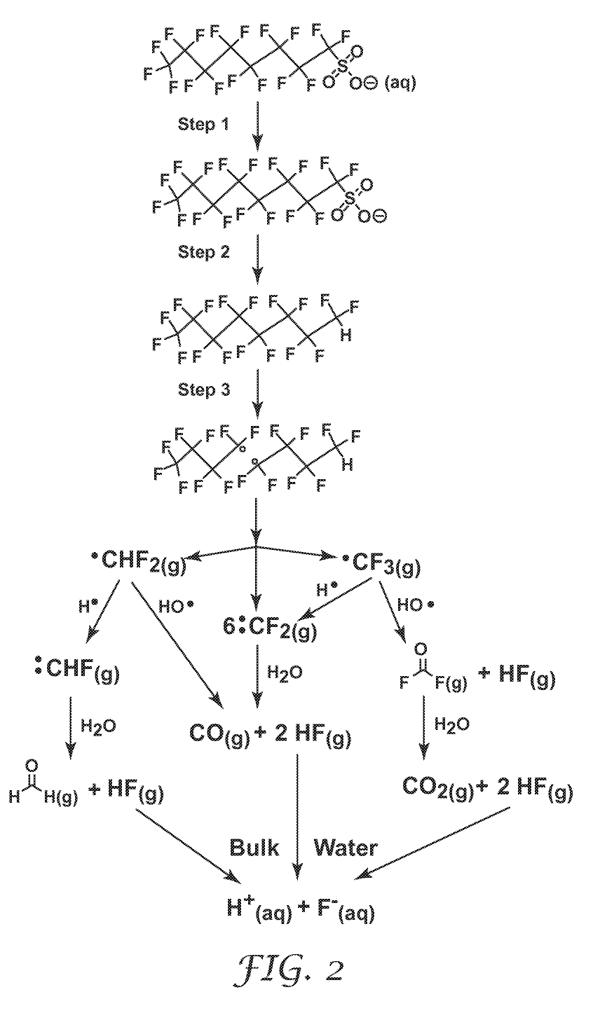

A schematic representation of the general degradation sequence occurring during the ultrasonically induced cavitation of PFOS is illustrated in FIG. 2. A surfactant such as PFOS is typically driven preferentially to the bubble-water interface during ultrasonically induced cavitation where the fluorochemical is adsorbed onto the bubble surface, as indicated in step 1 of FIG. 2. The bubble then collapses (see step 2) creating sufficient heat to initiate pyrolysis of the fluorochemical. The interfacial (e.g., gas/water interface) temperature minimums are estimated to be about 800° K. upon bubble collapse.

At 358 kHz and 250 W/L, the measured pseudo first-order degradation rate constant for PFOA is 0.045 min⁻¹. By analysis of the headspace gas generated during the ultrasonic treatment of PFOA or PFOS in water, 20 polyfluorinated alkanes and 52 polyfluorinated alkenes have been noted. The polyfluorinated alkanes are predominantly CHF₃, CH₂F₂, CH₃F, C₂F₅H, and C₃F₇H while the polyfluorinated alkenes include species such as CF₂H₂, C₂F₄, C₃F₆ and many C₄-C₈ polyfluorinated alkenes of slightly lower abundance; the total accounting for <1% of the total fluorine at any time. The degradation of intermediate species (e.g. polyfluorinated radicals) (see FIG. 2, step 2) during ultrasonically induced cavitation proceeds faster that the initial decomposition of the PFOS surfactant. The enhanced rates of the non-ionic intermediates compared to their ionic analogs is due to their increased susceptibility toward oxidation, and their larger Henry's Law constants, which favors partitioning of the neutral intermediates into the vapor phase of the bubbles where the maximum temperatures can reach up to 5000° K.

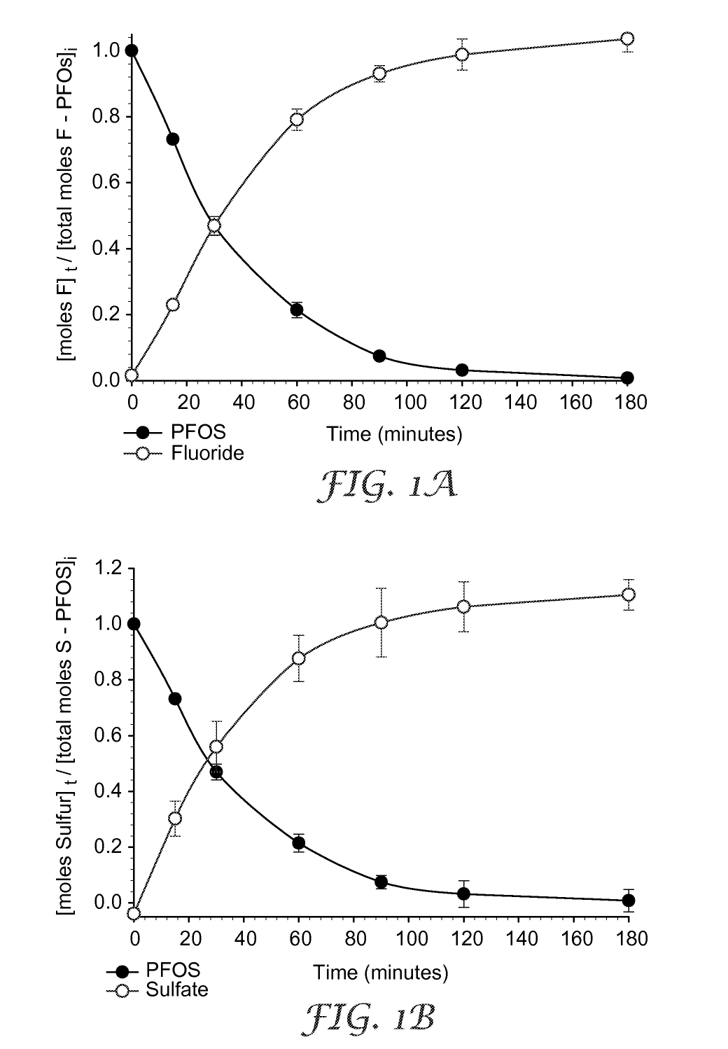

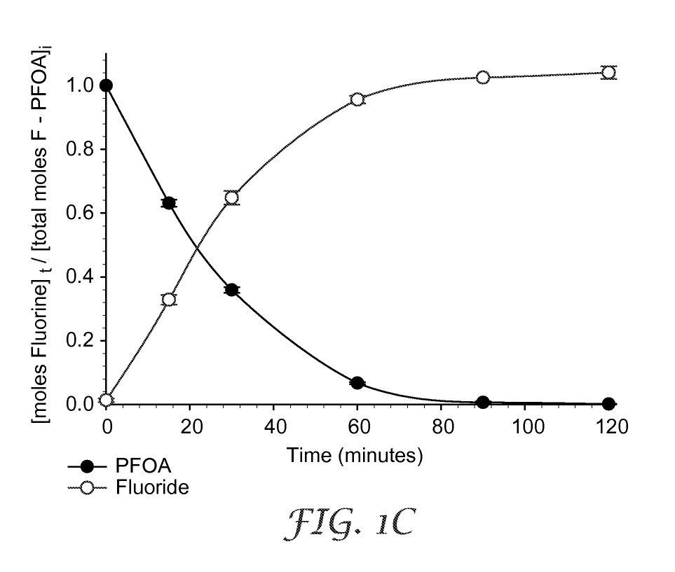

The fluorochemical sulfonate moiety (—CF₂—SO₃⁻) is converted quantitatively to simple sulfate (SO₄²⁻) (e.g., see FIG. 1B) at a rate similar to the loss of PFOS, so that:

−d[PFOS]/dt)≈+d[SO₄²⁻]/dt.

While not wishing to be bound to a particular theory, it is believed that PFOS pyrolysis likely proceeds via the formation of sulfur oxyanion and other intermediates such as SO₃, SO₃F, HSO₃⁻, or SO₃²⁻ which are readily hydrolyzed or oxidized to SO₄²⁻.

Step 3, FIG. 2, illustrates that the degradation of the fluorinated intermediates within collapsing bubbles will occur initially through the breaking of covalent —C—C— bonds, thus producing two fluorinated alkyl radicals. At temperatures of about 2000° K., the estimated half life of the carbon to carbon bond is about 22 nanoseconds (ns).

As shown in step 4, FIG. 2, over the same temperature range as in step 3, the resulting fluorinated alkyl radicals have estimated thermal decomposition half-lives of less than one nanosecond with the subsequent production of difluorocarbene or tetrafluoroethylene fragments. These fragments, in turn, thermally decomposes to yield two difluorocarbenes and eventually a trifluoromethyl radical. The trifluoromethyl radical is believed to react with H-atom or hydroxyl radical to yield difluorocarbene or carbonyl fluoride respectively. The difluorocarbene produced will hydrolyze with water vapor to give a carbon monoxide and two hydrofluoric acid molecules. Carbonyl fluoride can also hydrolyze with water vapor to give carbon dioxide and hydrofluoric acid, which, at the appropriate pH (e.g., greater than 3) will dissociate upon solvation to a proton and fluoride. Fluorochemical fluoride is quantitatively converted to free fluoride (see, e.g., FIGS. 1A and 1C).

The carbon backbone of the fluorochemical is converted primarily to formate (HCO₂⁻), carbon monoxide and carbon dioxide. The nearly quantitative carbon mass balance is represented as

((HCO₂⁻+CO+CO₂)/nC_{FC})

### Where:

FC means fluorochemical;

n is number of carbons in the original fluorochemical.

The mass balance would provide additional evidence for a mechanism that involves the shattering of the perfluoro-alkene or perfluoro-alkane chains where the fluoride radicals are converted to HCO₂⁻+CO+CO₂ via secondary oxidation, reduction or hydrolysis.

The ultrasonic acoustic cavitation of aqueous solutions comprising fluorochemicals is an effective process for the degradation of these compounds over a wide range in concentrations, under ambient conditions, and without the use of chemical additives. Numerous applications are contemplated for the ultrasonic acoustic cavitation of aqueous fluorochemical systems. Specific electro-mechanical systems and devices are contemplated within the scope of the invention. In particular, systems and devices are contemplated for the treatment of groundwater that contains fluorochemicals and, possibly, other unwanted chemicals as well. In the treatment of groundwater, the use of ultrasonically induced cavitation has been problematic in that the use of ultrasonic transducers on a large scale is known to generate significant amounts of heat, thus requiring cooling. Moreover, large scale ultrasonic reactors can require a significant amount of space and may require large, unsightly containment structures that can take up a significant areas of ground space.

Embodiments of the invention are described for the treatment of groundwater that overcome the foregoing problems. Referring now to FIGS. 8-12, such systems and devices are illustrated and will now be described.

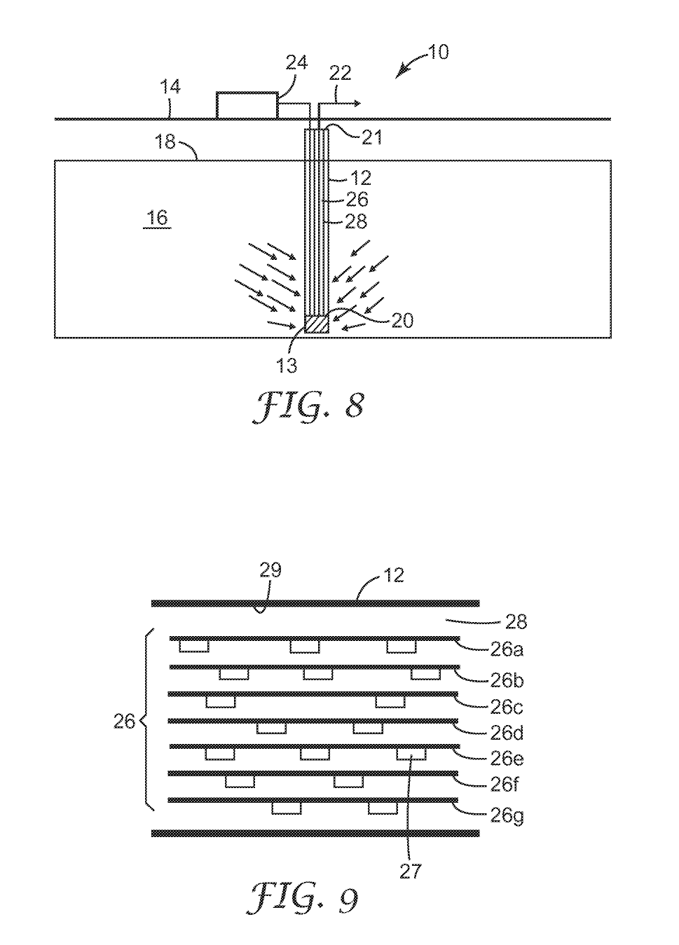

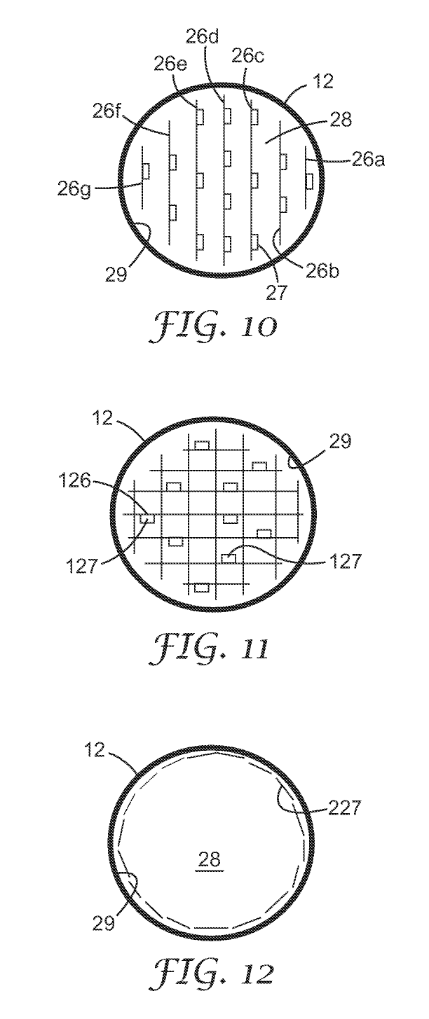

FIG. 8 illustrates a system 10 for the treatment of groundwater according to the present invention. The system 10 includes, as a first component, a well casing or pipe 12 shown as sunken below ground level 14 into a water table 16. The first component or pipe 12 extends below the uppermost surface 18 of the groundwater table 16 and the first or distal end 20 thereof is attached to a pump, represented as component 13, which serves as an inlet for the groundwater to enter the system 10 for ultrasonically induced cavitation and for extraction of the water from the table 16. Groundwater is drawn from the table 16 to the pump 13 and through the distal end 20 of pipe 12 and is drawn or pumped up and out of the table 16, exiting the pipe 12 through the second or proximal end 21, all in much the same manner as in a conventional groundwater well, for example. The first component or pipe 12 includes an interior space 28 (see, e.g., FIGS. 9 and 10) defined by inner wall 29 and extending between first end 20 and second end 21. A lattice 26 supports at least one ultrasonic transducer 27. In some embodiments, a plurality of ultrasonic transducers 27 are provided, as shown in FIGS. 9 and 10, in sufficient numbers to facilitate ultrasonically induced cavitation within the pipe 12 while water travels therethrough or remains resident therein. Station 24 is located above ground level 14 and includes a power supply and a radio frequency (RF) generator. The power supply serves as a source of electrical power for the system 10 and for the RF generator set at an ultrasonic frequency at which the ultrasonic transducers are operative. Station 24, in turn, may be connected to an available electrical utility (not shown) or the like.

Referring particularly to the well casing or pipe 12, the lattice 26 is provided as comprising longitudinally extending plates 26a-g (e.g., FIG. 10) positioned in the interior space 28 of the pipe 12 to support ultrasonic transducers 27 thereon. In the embodiment of FIG. 10, the plates 26a-g are positioned in the interior space 28 of the pipe 12, supported in an known manner along the inner wall 29 and arranged in a parallel array that longitudinally spans the interior length of the pipe 12. Transducers 27 are positioned along the lattice 26 in a manner that maximizes the cavitation within the pipe 12. The placement and number of the transducers 27 is dependent on the ultrasonic frequency being employed, the internal diameter of the pipe 12, and other factors know to those skilled in the art. In this construction, ultrasonically induced cavitation can be applied to a stream of water as it travels through the interior space 28 along the length of the pipe 12 prior to emerging from the groundwater table 16 through the proximal end 21 and being dispensed or re-routed via the outlet 22. Cavitation to the stream of water will initiate the degradation reactions for fluorochemicals present in the water, as previously described. Water emerging through the outlet 22 has reduced levels of fluorochemicals and/or other chemicals. If needed or desired, the water stream may be further treated by filtration or the like.

In some embodiments, the plates 26 may be continuous (e.g., running the entire length of the pipe 12), while other embodiments may utilize plates that are discontinuous or discrete so that the plates run in a broken or discontinuous arrangement along the length of the pipe 12. Continuous and discrete plates may also be combined in a single construction. Moreover, the plates 26 may be positioned at any location or discrete region along the length of the pipe 12 or they may be positioned along the entire length of the pipe 12, as depicted in FIG. 8. Those skilled in the art will also appreciate that more plates can be added to the plates 26a-g in the lattice 26, or fewer plates than the plates 26a-g may be adequate as well, depending on the specific design of the system 10.

The system 10 is advantageously constructed so that the number of additional components to cool the system can be minimized or eliminated entirely. In the embodiment shown in FIG. 8 and described herein, the system 10 is cooled by surrounding earth, providing a heat sink that helps to maintain the pipe 12 and the water being treated at cool temperatures. Therefore, costs associated with additional cooling equipment is eliminated and the overall energy costs associated with ultrasonic acoustic cavitation are reduced. Moreover, the majority of the system 10 is underground thus improving the overall appearance of the treatment site and possibly allowing for multiple uses for the site 10. Moreover, the residence time of the water (at a desired flow rate of water) in the pipe 12 can be easily selected and would require relatively small changes in well diameter. In the event lower frequency ultrasound (e.g., audible to humans) is required, the resulting sounds from such a system would be minimized because the sound would be emitted underground.

In an area where large scale treatment of groundwater is needed, several treatment systems (such as system 10) could be drilled near each other in a honeycomb or other configuration to allow relatively large volumes of water to be removed but still providing the groundwater with adequate residence times within the first component 12 during ultrasonically induced cavitation to facilitate significant fluorochemical degradation.

Other configurations are contemplated for the lattice and the placement of ultrasonic transducers thereon within the pipe 12. Referring to FIG. 11, for example, transducers 127 may be mounted on interconnected plates 126 arranged in a grid or honeycomb-type pattern, supported in a known manner along inner wall 29, and extending fully or partly along the inner space 28 of the pipe 12 between the proximal end 21 and distal end 22.

In still another embodiment shown in FIG. 12, transducers 227 can be positioned within the interior space 28 around the inner wall 29 of the pipe 12, essentially around the entire inner diameter thereof. In this embodiment, the transducers 227 are placed directly on the inner wall 29 of pipe 12, and ultrasonically induced cavitation of a water stream moving through the pipe 12 would be focused near the center of the interior space. Variations to the foregoing embodiment are contemplated as well. For example, the transducers 227 may also be mounted on plates (not shown), as in the previously described embodiments, and the plates may then be positioned within the interior space 28 of the pipe 12 along the inner wall 29 thereof. Additionally, the transducers 227 may be as numerous as shown or may be reduced in overall number, depending on the design criteria for the particular system.

In any of the depicted embodiments, it will be appreciated that the systems and components depicted in the various Figures are not drawn to scale.

In the foregoing embodiments, transducers may be operated at high frequency (100 to 1000 kHz), if needed to minimize sonochemical degradation of the surfaces of the well casing or pipe. Those skilled in the art will appreciate, however, that the frequency is not a requirement of the system. Water pumped through this well casing or piping is exposed to ultrasound, the fluorochemicals (and other chemicals present in the water) are transformed by the acoustically driven collapsing bubbles as well as the oxidants produced during the collapse of the bubbles.

In still another embodiment, the invention can be provided as a component in a reactive barrier for the remediation of groundwater. In this embodiments, the a lattice as previously described can be inserted within the barrier trench in a configuration that spans the entire length thereof. In this manner, groundwater percolating through the barrier may be ultrasonically treated by ultrasonically induced cavitation while the water resides within the trench. The transducers would be associated with a power source and RF generator, as described previously. In this embodiment, the lattice for supporting one or more ultrasonic transducers could be configured as previously described, in a parallel array of plates or in a honeycomb pattern, for example. However, the configuration of the lattice is not to be construed as limited in any manner.

In water containing a substantial number of components in addition to fluorochemicals, slower reaction rates are possible during the degradation process described herein. This may be the case in landfill leachate or water associated with other waste storage sites.

### EXAMPLES

Additional embodiments of the invention are further described in the following non-limiting Examples.

### Procedure A: Standards and Reagents

Ammonium perfluorooctanoate (APFO) and sodium perfluorooctane sulfonate (NaPFOS) standards were obtained from 3M Company of St. Paul, Minn. The standards from 3M Company included both linear and branched isomers of APFO and PFOS in methanol and were diluted to obtain a desired concentration for PFOS and/or PFOA.

Perfluorobutanoic acid (PFBA) was obtained from Sigma-Aldrich. Sodium perfluorobutane sulfonate (NaPFBS) was obtained from 3M Company of St. Paul, Minn. The samples were diluted to obtain a desired concentration for PFBA and/or PFBS.

### Procedure B: Ultrasonic Acoustic Cavitation Experiments

Ultrasonic Acoustic Cavitation experiments were conducted at frequencies of 205, 358, 618 and 1078 kHz were performed using an ultrasonic generator (from L-3 Nautik GMBH in Germany) in a 600 mL glass reactor. The temperature was controlled with a refrigerated bath (either a Haake A80 or Neslab RTE-111) maintained at 10° C.

For mass balance experiments, the L-3 Nautik reactor was sealed to atmosphere for trace gas analysis.

Ultrasonic acoustic cavitation experiments at 20 kHz were performed with an ultrasonic probe (Branson Cell Disruptor from Branson Ultrasonics Corporation of Danbury, Conn.) in a 300 mL glass reactor. The titanium probe tip was polished prior to use for all experiments and on every hour for some. The temperature was controlled with a refrigerated bath (Haake FK2) at 10° C.

### Procedure C: Water Analyses

Ammonium Acetate (>99%) and Methanol (HR-GC>99.99%) were obtained from EMD Chemicals Inc. Aqueous solutions were used in liquid chromatography/mass spectroscopy (LC/MS) and were prepared with purified water prepared using a Milli-Q water purification system (18.2 mΩ cm resistivity) obtained from Millipore Corporation of Billerica, Mass.

Analysis for initial fluorochemicals and possible shorter-chain degradation products was completed by high performance liquid chromatography mass spectroscopy (HPLC-MS). Sample aliquots (700 μL) were withdrawn from the reactor using disposable plastic syringes. The samples were placed into 750 μL polypropylene autosampler vials and sealed with a polytetrafluoroethylene (PTFE) septum crimp cap. For reactions with initial fluorochemical concentrations greater than 250 ppb, serial dilutions to achieve a concentration around 500 ppb were completed prior to analysis. 20 μL of collected or diluted sample was injected onto an Agilent 1100 LC for separation on a Betasil C18 column (Thermo-Electron) of dimensions 2.1 mm ID, 100 mm length and 5 μm particle size. A 0.01 M aqueous ammonium acetate-methanol mobile phase at a flow rate of 0.3 mL/min was used with an initial composition of 70:30 aqueous:methanol holding for two minutes followed by a six minute ramp to 25:75 holding for six minutes, then a minute ramp to 0:100 and a 1 minute hold to wash the column and finally a minute ramp back to initial conditions. Separated samples were analyzed by an Agilent Ion Trap in negative mode monitoring for the perfluoro-sulfonate molecular ion and the decarboxylated perfluorocinated-acid. The nebulizer gas pressure was 40 PSI, drying gas flow rate and temperature were 9 L/min and 325° C., the capillary voltage was set at +3500 V and the skimmer voltage was −15 V. Quantification was completed by first producing a calibration curve using 8 concentrations between 1 ppb and 200 ppb fitted to a quadratic with 1/X weighting.

### Procedure D: Ion Chromatography

Ion chromatography was used to determine the concentration of fluoride and sulfate. Sample preparation included dilution of the samples by a factor 1:100 to get the samples within the operating range of the ion chromatography equipment. The following equipment and operating parameters were employed in the analysis of the sample replicates.

### Dionex DX500 Chromatography System

Dionex GP50 Standard bore Gradient Pump

### Dionex ASRS Ultra II 4 mm Suppressor

### Dionex CD20 Conductivity Detector

### Dionex AS11A Column, 4 mm

### Dionex AG11A Guard Column, 4 mm

### Dionex AS40 Autosampler, Inert Peek Flow Path

Eluent: 18-MΩ·cm water, 0.2-35 mM KOH by EG40 Eluent Generator

### Injection: 250 μL

Flow Rate: 1.0 mL/min.

A calibration curve was obtained and the data was quantified using at least a 5-point point linear calibration curve. The correlation coefficient was at least 0.998 for each analyte and the curve was not forced through zero. The lower limit for quantification was the lowest standard concentration employed. The calibration standards were prepared from a mixed anion stock (Mix 5) purchased from Alltech Associates, Inc., Lot # ALLT170051 and a 99% trifluoroactic acid standard from ACROS Lot # B0510876. Standards were diluted with Milli-Q (18 MΩ·cm) water.

Continuing Calibration Verifications (CCVs) were run at least every 10 sample injections and at the end of each analytical sequence to verify consistent system operation. The CCV recoveries ranged from 97-102%. Continuing Calibration Blanks (CCBs) containing 18 MΩ·cm water (extraction solution) were analyzed after every 10 injections and at the end of each analytical sequence to verify that the system operation was consistent.

Method blanks containing 18 MΩ·cm water (extraction solution) were prepared and analyzed. The target analytes were not detected above the method reporting limit. Method spikes were prepared and analyzed. A vial containing extraction water was spiked with a mid-level certified standard containing all three analytes. The average method spike recoveries ranged from 98-111%. Matrix spikes were prepared and analyzed in duplicate. Three individual vials containing 1:100 diluted sample were spiked with a certified standard containing all three analytes. The average matrix spike recoveries ranged from 95-102%, 95-107%, and 103-115%.

### Procedure E: Trace Gas Analysis

The gaseous headspace was analyzed for trace gases. A reactor sealed from the outside atmosphere was used for these measurements and any gases formed were not circulated back into solution. For headspace gas analysis, a 300 mL gas reservoir was added to the recirculation line. A similar sized evacuated can was used to collect the gas content of the headspace. The can was sent for analysis using gas chromatography/mass spectroscopy (GC-MS) as well as by real-time FTIR (Model-I2001, 4 meter white cell, available from Midac Corporation of Costa Mesa).

### Example 1

Multiple PFOS and PFOA solutions were prepared as in Procedure A at initial concentrations of about 10 μM for each of the two fluorochemicals (note: 1 ppm=2.0 μM PFOS and 2.4 μM PFOA). The initial solution pH was ˜6.5 for PFOA⁻NH₄⁺ and ˜8.0 for PFOS⁻K⁺, and the pH was maintained above 4.5 to prevent formation of hydrofluoric acid (pKa=3.14). Ultrasonic Acoustic Cavitation was applied to the PFOS and PFOA solutions according to Procedure B at an acoustic frequency of 358 kHz and a power density of 250 W/L.

Degradation of the fluorochemicals was monitored. The initial fluorochemicals PFOS and PFOA were monitored by analysis of water samples using LC/MS according to Procedure C above. Aqueous fluoride ion, formate ion, and sulfate were monitored by ion chromatography according to Procedure D above. Carbon monoxide (CO) and carbon dioxide (CO₂) were monitored using FTIR as in Procedure E. Additionally, analysis of the gaseous headspace in the reactor by FTIR and GC-MS according to Procedure E showed trace levels of a number of polyfluorinated alkanes and olefins. Release of CO and CO₂ to the overlying headspace occurred immediately after the initial pyrolytic decomposition of the parent compounds.

Referring to FIGS. 1A-1C, mass balance determinations of total fluorine and sulfur as functions of time are shown. These plots show the degradation of the initial fluorochemicals and the concomitant increase in fluoride ion and sulfate concentrations.

### Example 2

Multiple solutions of PFOA and PFOS were prepared according to Procedure A. Samples of PFOA were made to cover the concentration range from 0.01 mg/L to 990 mg/L, and samples of PFOS were made to cover the concentration range from 0.01 mg/L to 820 mg/L. The samples were subjected to ultrasonically induced cavitation at a frequency of 358 kHz and a power density of 250 W/L using an ultrasonic generator from L-3 Nautik GMBH in Germany and a 600 mL glass reactor as in Procedure B. Degradation of PFOA and PFOS were monitored by analysis of water samples using LC/MS according to Procedure C above. The degradation data was used to prepare plots of ln([PFOS]ₜ−[PFOS]ᵢ) versus time and ln([PFOA]ₜ−[PFOA]ᵢ) versus time (where t indicates a concentration at a certain time and i indicates initial concentration). The slope of these plots were taken as the pseudo first order rate constants.

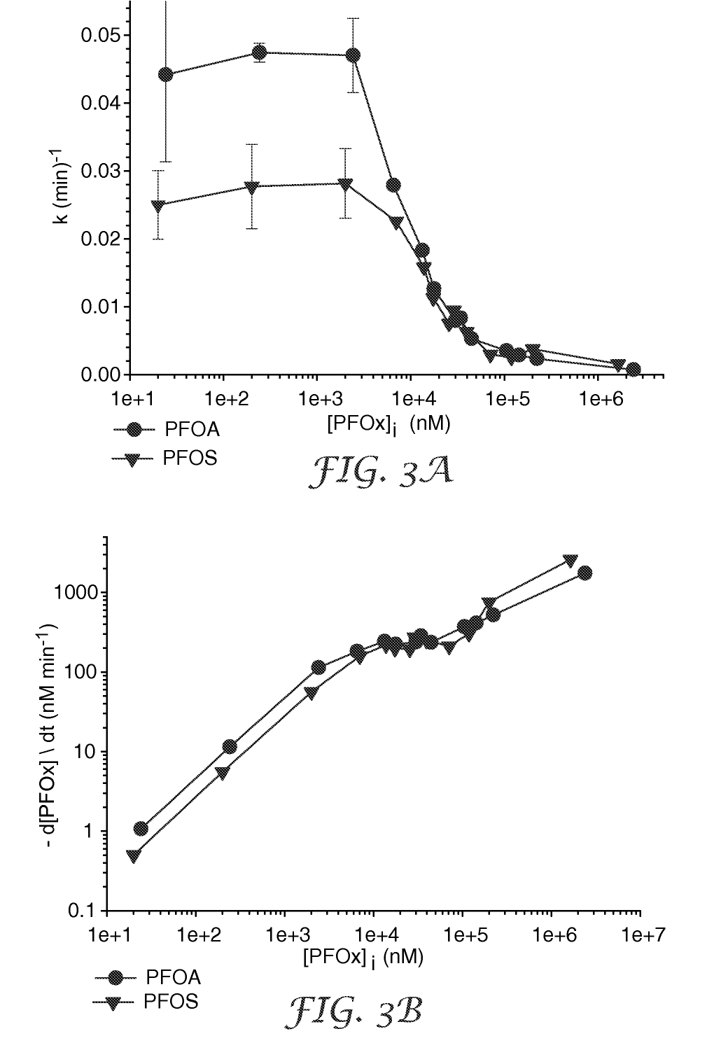

Referring to FIG. 3A, the pseudo first-order rate constants have been plotted against initial concentrations of PFOA and PFOS. In the concentration range of 20 nM to 2000 nM, the rate constants are 0.047 min⁻¹ and 0.028 min⁻¹ for PFOA and PFOS, respectively. Over the concentration range of 2000 nM and 40,000 nM, the pseudo first-order rate constant decreases linearly with a slope of −10⁻³ min⁻¹ μM⁻¹ In FIG. 3B absolute degradation rates of PFOS and PFOA are plotted against the initial concentrations of the fluorochemicals. Between 20 nM and 2000 nM, the absolute degradation rates increase by two orders of magnitude from 1.1 to 113 nM min⁻¹ for PFOA and from 0.5 to 56 nM min⁻¹. Between 6000 nM and 140,000 nM, the absolute rate of degradation levels off at around 200 nM min⁻¹.

The decrease in the apparent rate constant and leveling off of the absolute rate over the depicted concentration range suggests a change in sorption regimes from a linear sorption isotherm to a non-linear sorption isotherm which can be described by a Langmuir isotherm where

Γ_{FC}=Γ_{FC,max}[K_{L}[FC]/1+K_{L}[FC]].
where
   FC means fluorochemical;
   Γ_{FC} is the surface concentration of a fluorochemical;
   Γ_{FC,max} is the maximum surface concentration of a fluorochemical; and
   K_{L} is the equilibrium adsorption coefficient.

Thus, the absolute rates of degradation reach a saturation level as the available surface sites on the bubble are fully occupied. In addition, convergence of the rate constants for PFOA and PFOS degradation is

−(d[PFOA]/dt)≈−(d[PFOS]/dt),

suggesting the overall rates are sorption controlled rather than thermally controlled. In this concentration regime, the apparent first-order rate constant actually increases with time because as the concentration of PFOx is decreased. The fraction of PFOx adsorbed to the surface of an ultrasonically induced cavitation bubble is [PFOx]_{surface}. The total amount of PFOx is [PFOx]ₜₒₜₐₗ. The ratio [PFOx]_{surface}/[PFOx]ₜₒₜₐₗ increases with time and shifts towards a steeper region of the sorption isotherm.

Above 40,000 nM, the observed pseudo first-order rate constants reach an apparent constant value of 0.0025 min⁻¹ at a PFOS (or PFOA) concentration of 40,000 nM and the apparent pseudo order of the reaction shifts from first order to zero order as the bubble surface nears saturation. However, above 40,000 nM, the absolute rate of PFOS (or PFOA) degradation appears to increase. Surfactant accumulation will result in a decrease in surface tension. The formation of acoustically driven bubbles requires that the applied acoustic power must be greater than the total bubble surface energy,

Π≧N_{b}σ<S>
Where
   Π is the applied power in Watts;
   N_{b} is the total number of bubbles;
   σ is the surface tension in N/m; and
   <S> is the average bubble surface area in cm².

Therefore, as surface tension is decreased, the total number of bubbles, and the number of available surface sites increases allowing for greater degradation rates. As a consequence, the observed saturation effect is the product of offsetting effects of surface sites limitation and surface tension reduction.

### Example 3

Multiple solutions of PFOA and PFOS were prepared according to Procedure A to a concentration of 100 ng/ml per fluorochemical. The samples were subjected to ultrasonically induced cavitation at a frequency of 618 kHz at different power densities using an ultrasonic generator from L-3 Nautik GMBH in Germany and a 600 mL glass reactor as in Procedure B. Degradation of PFOA and PFOS were monitored by analysis of water samples using LC/MS according to Procedure C above. The degradation data was used to prepare plots of ln([PFOS]ₜ−[PFOS]ᵢ) versus time and ln([PFOA]ₜ−[PFOA]ᵢ) versus time (where t indicates a concentration at a certain time and i indicates initial concentration). The slope of these plots were taken as the pseudo first order rate constants. Operating parameters and rate constants are set forth in Table 1.

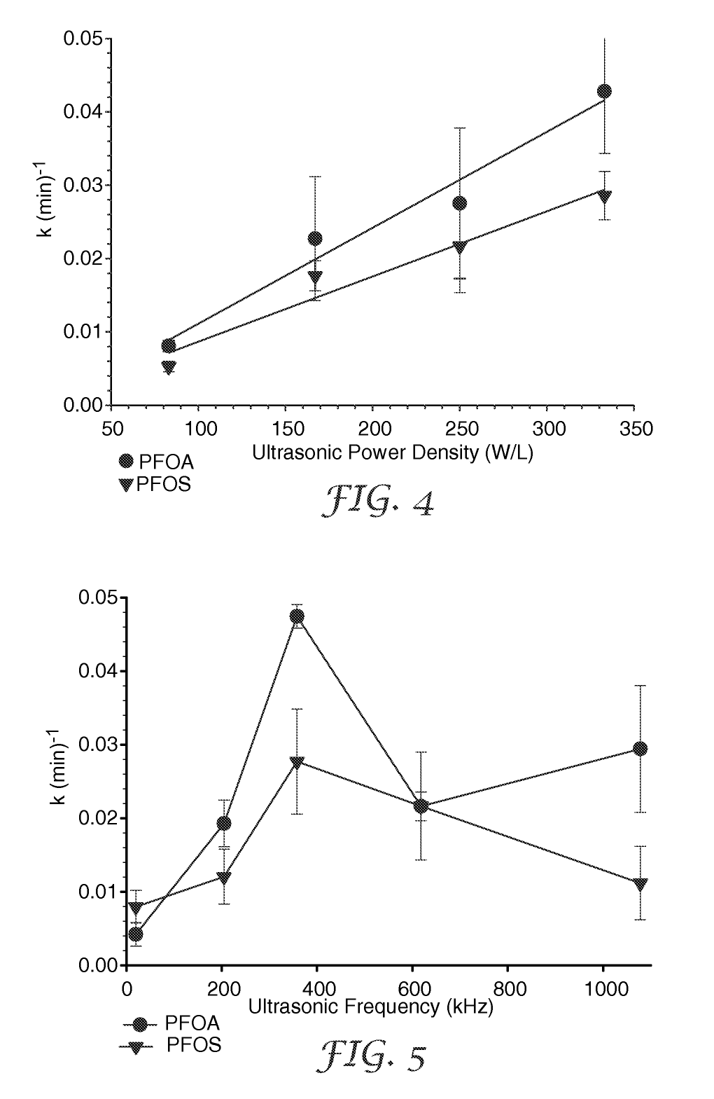

The observed dependence of the pseudo first-order rate constants on the ultrasonic power density at 618 kHz is set forth in the plot of FIG. 4. The measured rate constants increase with increasing power density for both fluorochemicals, as shown in FIG. 4. An increase in power density increases the number of cavitation bubbles (N_{b}), and in turn the total number of surface catalytic sites.

TABLE 1

| | | | | |
|---|---|---|---|---|
| Frequency (kHz) | 618 | 618 | 618 | 618 |
| Applied Power (W) | 50 | 100 | 150 | 200 |
| Calorimetric Power | 33 | 78 | 125 | 188 |
| (W) | | | | |
| Acoustic Pressure (bar) | 2.05 | 3.15 | 3.99 | 4.89 |
| Acoustic Half-Period | 0.8 | 0.8 | 0.8 | 0.8 |
| (us) | | | | |
| Collapse Time (us) | 0.25 | 0.3 | 0.35 | 0.4 |
| Rmax (micron) | 4.25 | 7.91 | 10.4 | 13.1 |
| Tmax (K, gas) | | | | |
| k[PFOA] expt min−1 | 0.0081 | 0.0227 | 0.0275 | 0.0428 |
| k[PFOS] expt min−1 | 0.00525 | 0.0176 | 0.0217 | 0.0286 |

### Example 4

Multiple solutions of PFOA and PFOS were prepared according to Procedure A so that each fluorochemical was present in solution at a concentration of 100 ng/mL. The solutions were subjected to ultrasonic acoustic cavitation experiments at frequencies of 20, 205, 358, 618 and 1078 kHz as described in Procedure B. Degradation of PFOA and PFOS were monitored by analysis of water samples using LC/MS according to Procedure C above. The degradation data was used to prepare plots of ln([PFOS]ₜ−[PFOS]ᵢ) versus time and ln([PFOA]ₜ−[PFOA]ᵢ) versus time (where t indicates a concentration at a certain time and i indicates initial concentration). The slope of these plots were taken as the pseudo first order rate constants.

Referring to FIG. 5, the degradation rate as a function of ultrasonic frequency is shown for PFOA and PFOS. Over the frequency range from 20 to 1078 kHz, the degradation rates for both PFOS and PFOA have maximums at 358 kHz.

### Example 5

Samples of groundwater and landfill leachate (or porewater) were obtained. Additionally, solutions of 100 ng/ml of PFOS were prepared as in Procedure A. All of the solutions were subjected to ultrasonic acoustic cavitation experiments at a frequency of 358 kHz and a power density of 250 W/L as described in Procedure B. The degradation of PFOS was monitored by analysis of water samples using LC/MS according to Procedure C.

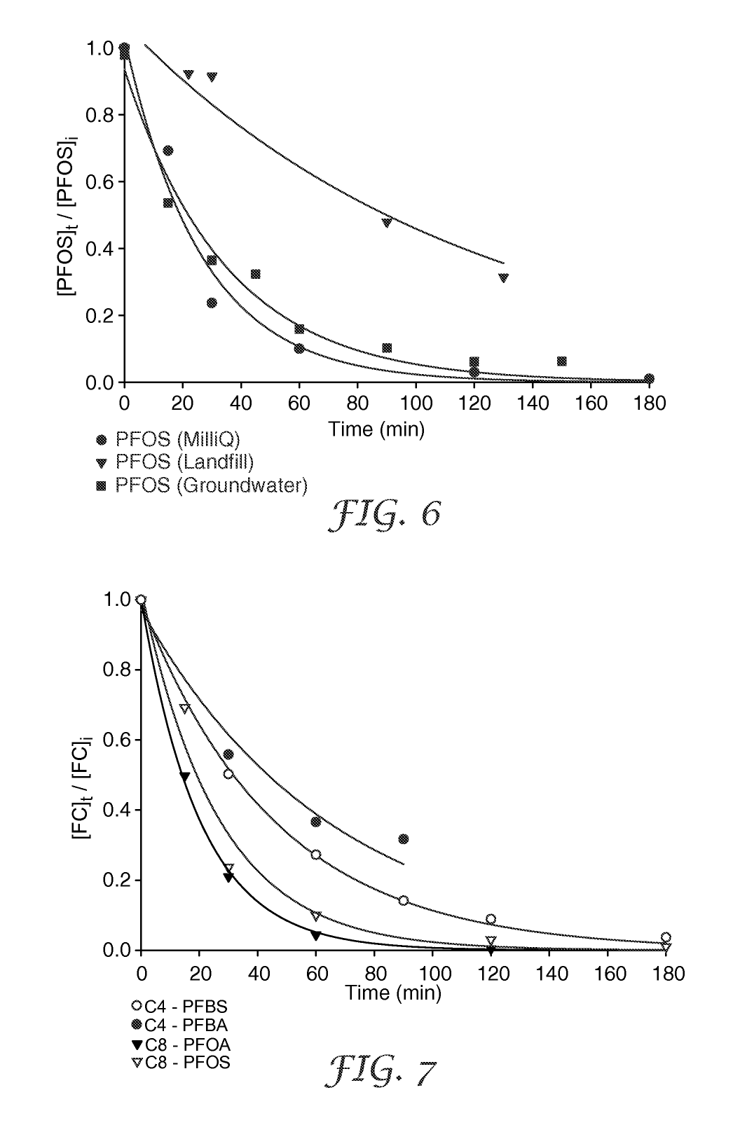

The pseudo first order rate constants were 0.03 min⁻¹, 0.03 min⁻¹ and 0.008 min⁻¹ for PFOS present in purified water, groundwater and landfill leachate, respectively. Referring to FIG. 6, the concentration of PFOS at a given time divided by its initial concentration is plotted as a function of time for each of the samples tested.

### Example 6

Multiple solutions of PFOA, PFOS and smaller C₄ fluorochemicals (perfluorobutane sulfonate and perfluorobutanoic acid) were prepared to have a concentration for each fluorochemical of 100 ng/ml. Solutions of PFOA and PFOS were prepared according to Procedure A. The samples were subjected to ultrasonically induced cavitation at a frequency of 358 kHz at a power density of 250 W/L using an ultrasonic generator from L-3 Nautik GMBH in Germany and a 600 mL glass reactor as in Procedure B. Degradation of the fluorochemicals was monitored by analysis of water samples using LC/MS according to Procedure C above. The degradation data was used to prepare plots of the concentration of fluorochemical at a given time divided by its initial concentration as a function of time. The pseudo first order rate constants were 0.021 min⁻¹ for PFBS, 0.015 min⁻¹ for PFBA, 0.04 min⁻¹ for PFOA and 0.03 min⁻¹ for PFOS. The resulting degradation curves are set forth in FIG. 7.

Embodiments of the invention have been described in detail. Those skilled in the art will appreciate that changes and modifications to the described embodiments may be made without departing from the spirit and scope of the invention.

What is claimed is:

1. A system for the treatment of groundwater, comprising:
A first component for placement into a groundwater table, the first component having a first end and a second end and an interior space defined by an inner wall and extending between the first end and the second end;
At least one ultrasonic transducer positioned with the interior space of the first component to provide ultrasonically induced cavitation to a volume of water within the interior space;
A pump associated with the first end of the first component to draw water from the groundwater table into the interior space of the first component;
An outlet associated with the second end of the first component, the outlet positioned to direct a volume of water away from the first component after the water has passed therethrough;
A power supply; and
A radio frequency generator capable of providing a radio frequency within the range from about 15 kHz to about 1100 kHz.

2. The system of claim 1 wherein the first component is a pipe.

3. The system of claim 1 wherein the at least one transducer is mounted on the inner wall of the first component.

4. The system of claim 3 wherein the at least one transducer comprises a plurality of transducers mounted on the inner wall of the first component.

5. The system of claim 1 wherein the system further comprises a lattice within the interior space of the first component, the at least one transducer supported on the lattice.

6. The system of claim 5 wherein the lattice comprises a series of at least two parallel plates extending between the first end and the second end of the first component.

7. The system of claim 5 wherein the lattice comprises a honeycomb pattern of interconnected plates extending between the first end and the second end of the first component.

8. The system of claim 1 wherein the at least one transducer operates to provide ultrasonically induced cavitation at a frequency greater than 200 kHz.

9. The system of claim 1 wherein the at least one transducer operates to provide ultrasonically induced cavitation at a frequency within the range from greater than 200 kHz to about 1100 kHz.

10. The system of claim 1 wherein the at least one transducer operates to provide ultrasonically induced cavitation at a frequency within the range from greater than 200 kHz to about 600 kHz.

11. The system of claim 1 wherein the at least one transducer operates to provide ultrasonically induced cavitation at a frequency of about 20 kHz, about 205 kHz, about 358 kHz, about 500 kHz, about 618 kHz, or about 1078 kHz.

12. A process for the treatment of fluorochemicals in an aqueous environment, comprising:
Providing a system as described in claim 1 wherein the first component and the pump are sunken below ground level into a groundwater table, the first end of the first component attached to the pump;
Drawing a volume of water into the interior space of the first component through the pump and the first end of the first component, the volume of water comprising fluorochemicals;
Ultrasonically inducing cavitation within the interior space at a frequency within the range from about 15 kHz to about 1100 kHz to thereby break down the fluorochemicals into constituent components; and
Removing the volume of water from the interior space through the second end thereof.

13 The process of claim 12 wherein the ultrasonically induced cavitation is performed at a frequency greater than 200 kHz.

14. The process of claim 12 wherein the ultrasonically induced cavitation is performed at a frequency within the range from greater than 200 kHz to about 1100 kHz.

15. The process of claim 12 wherein the ultrasonically induced cavitation is performed at a frequency within the range from greater than 200 kHz to about 600 kHz.

16. The process of claim 12 wherein the ultrasonically induced cavitation is performed at the frequency of about 20 kHz, about 205 kHz, about 358 kHz, about 500 kHz, about 618 kHz or about 1078 kHz.

17. The process of claim 12 wherein the fluorochemicals comprise compounds having a carbon chain length of C₁ and higher.

18. The process of claim 12 wherein the fluorochemicals comprise compounds having a carbon chain length of C₂ and higher.

19. The process of claim 12 wherein the fluorochemicals comprise compounds having a carbon chain length selected from the group consisting of C₄, C₆, C₈ and combinations of two or more of the foregoing.

20. The process of claim 12 wherein the fluorochemicals comprise perfluorooctane sulfonate and perfluorooctanoic acid.
